(19) United States
(12) Patent Application Publication
(10) Pub. No.: US 2026/0264873 A1
(43) Pub. Date: Sep. 10, 2026

(54) MANAGEMENT OF THE DRAWING OF MECHANICAL POWER FROM A TWO-SPOOL OR THREE-SPOOL TURBINE ENGINE

(71) Applicant: SAFRAN AIRCRAFT ENGINES, Paris (FR)

(72) Inventors: Romain Guillaume CUVILLIER, MOISSY-CRAMAYEL (FR); Amaury Jean OLIVIER, MOISSY-CRAMAYEL (FR); Thomas Laurent PIGEAUD, MOISSY-CRAMAYEL (FR)

(73) Assignee: SAFRAN AIRCRAFT ENGINES, Paris (FR)

(21) Appl. No.: 18/993,374

(22) PCT Filed: Jul. 13, 2023
(86) PCT No.: PCT/FR2023/051088

§ 371 Date: Jan. 10, 2025

(30) Foreign Application Priority Data
Jul. 13, 2022 (FR) FR2207240

(51) Int. Cl. B64D 41/00; F02C 7/32

(52) U.S. Cl. CPC B64D 41/00; F02C 7/32

(57) ABSTRACT

The present invention relates to a method and system for managing the drawing of mechanical power from a two-spool or three-spool turbine engine (1) for an aircraft, in which at least two electric machines (3, 4) are suitable for recovering mechanical energy, one from a shaft driven by one of the turbines of the turbine engine (1), the other from a shaft driven by another turbine, in which the distribution of the drawing between one and the other of the two electric machines (3, 4) is controlled dynamically according to the phases of flight.

### FIELD OF THE INVENTION

This invention relates to a system and a method for managing the drawing of mechanical power from a two-spool or three-spool turbine engine.

### PRIOR ART

Conventionally, in addition to generating a thrust, an aircraft turbine engine is also used as a source of mechanical power for the generation of the electrical power needed for the requirements of the aircraft. Generally, this mechanical power from the turbine engine is extracted from the high-pressure shaft, which imposes heavy limitations on the operability of the high-pressure compressor, and also on that of the low-pressure compressor (or “booster”).

Moreover, systems for managing the drawing of electrical power consider engines as constantly available sources. As long as the power consumption requirements are within current ranges which are considered as acceptable, no attempt is made to control or optimize the levels of power drawn.

However, such an operation is increasingly incompatible with the significant reductions in idle thrust requirement of the latest generations of aircraft, which are a consequence of the increase in the lift-to-drag ratio of airplanes.

The descent phase is particularly affected. Specifically, this phase, characterized by its rate (in feet/minute) or its descent gradient (in degrees), is essentially limited by the lift-to-drag ratio of the airplane, the latter affecting up to 90% of the descent rate. Thus an increase in the lift-to-drag ratio must be compensated for by a significant decrease of the idle thrust to maintain a target descent rate.

However, the reduction in idle thrust is contradictory to the drawing needs for electrical power: the surge margin and the capacity of acceleration of the HP compressor are limited by the relative power draws with respect to the power of the HP turbine, since the engine components, the HP compressor and the LP compressor (“booster”) must be dimensioned to take into account scenarios of malfunction of the electrical generators.

Recently provision has also been made, in the context of hybrid-drive propulsion units, for new architectures implementing several mechanical draws. The first mechanical draw remains unchanged: the power is extracted from the HP shaft. A second mechanical draw is moreover performed from the LP shaft.

### SUMMARY OF THE INVENTION

A general aim of the invention is to improve the management of mechanical and electrical power draws, in order to make the developments in idle thrust reduction and the drawing requirements for electrical power as compatible as possible.

According to one aspect, for this purpose the invention makes provision for a system for managing the drawing of mechanical power from a twin-spool or three-spool aircraft turbine engine comprising at least a first turbine and a second turbine,
wherein at least a first electric machine and a second electric machine are suitable for recovering mechanical energy
   said first electric machine from a shaft driven by the first turbine of the turbine engine,
   said second electric machine from a shaft driven by the second turbine of the turbine engine,

Said system includes:
a managing unit which controls the draws of electrical power and the electrical distribution across the different equipment items and consumption systems of the aircraft, and
a control unit suitable for transmitting a distribution of the draws which it determines according to the flight phase of the aircraft, to said managing unit.

It has hence been identified by the inventors that the distribution of the draws has an effect on the operation of the turbine engine. Specifically, the mechanical draws affect the operating points of the components and the overall suitability of the turbine engine. Thus, for one and the same overall mechanical power requirement, the distribution will affect the consumption of fuel or else the engine thrust.

Typically, for example, in the case of a twin-spool turbine engine, with two generators suitable for recovering mechanical energy, one from the HP shaft, the other from the LP shaft, the generator on the LP shaft has different effects from those of the generator on the HP shaft, particularly on the margins of the compressors, on the thrust and on the specific fuel consumption (SFC).

The system for which provision is made has the advantage of allowing the following optimizations:
optimization of the specific fuel consumption (SFC);
optimization of the thrust;
optimization of the acceleration times
optimization of the turbine outlet temperature.

In particular, the presence of the generator on the LP shaft therefore adds a degree of freedom making it possible to find the best trade-off as a function of the desired criterion.

The invention also makes provision for a method for managing the drawing of mechanical power from a twin-spool or three-spool aircraft turbine engine comprising at least a first turbine and a second turbine, wherein at least a first electric machine and a second electric machine are suitable for recovering mechanical energy,
the first electric machine from a shaft driven by the first turbine of the turbine engine, and
the second electric machine from a shaft driven by the second turbine of the turbine engine,
the method implementing a control of the draws of electrical power and of the electrical distribution across the different equipment items and consumption systems of the aircraft,
wherein the distribution of these draws between the first electric machine and the second electric machine is controlled dynamically as a function of the flight phase.

It moreover concerns an assembly including a twin-spool or three-spool aircraft turbine engine comprising at least a first turbine and a second turbine, wherein at least a first electric machine and a second electric machine are suitable for recovering a mechanical energy,
the first electric machine from a shaft driven by the first turbine of the turbine engine, and
the second electric machine from a shaft driven by the second turbine of the turbine engine,
wherein said assembly further includes a managing system as previously described.

At least one of the electric machines can be a generator.

In the case where the turbine engine is of twin-spool type, the electric machines are suitable for recovering the mechanical energy, one from the high-pressure shaft, the other from the low-pressure shaft.

In the case of a turbine engine with a three-spool architecture, a third electric machine draws the mechanical energy the IP shaft (Intermediate Pressure).

### DESCRIPTION OF THE FIGURES

Other features, aims and advantages of the invention will become apparent from the following description, which is purely illustrative and nonlimiting, and which must be read with reference to the appended drawings on which:

FIG. 1 schematically illustrates an example of a managing system in accordance with an embodiment and a possible mode of implementation of the invention;

FIG. 2 schematically illustrates, in more detail, one possible implementation for the system of FIG. 1.

### DETAILED DESCRIPTION OF THE INVENTION

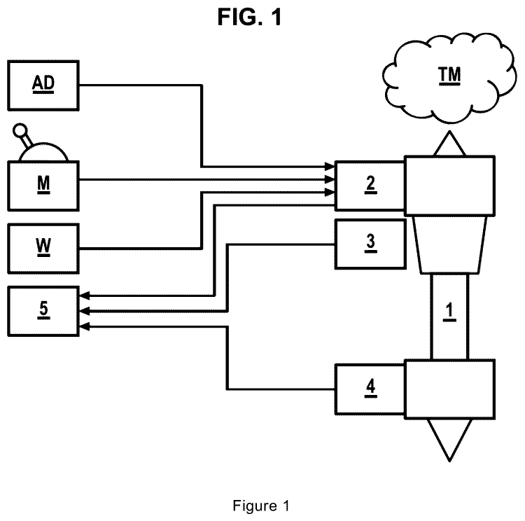

The assembly illustrated on FIG. 1 includes a twin-spool turboshaft engine 1, a control unit 2, a generator 3 which, using a power transmission system (not shown), recovers mechanical energy from the High-Pressure HP shaft, a generator 4 which itself recovers, using another power transmission system (also not shown), mechanical energy from the Low Pressure LP shaft A managing unit 5 controls the draws of electrical power from the outlet of the generators 3 and 4 and the electrical distribution across the different equipment items and consumption systems of the aircraft.

The control unit 2 and the managing unit 5 constitute the managing system of the proposed assembly.

The distribution between the power draws that the managing unit 5 performs from the generators 3 and 4 is determined by the engine control unit 2 and transmitted to said managing unit 5.

Typically, the input data taken into account for this purpose by the unit 2 are as follows:
the flight data of the aircraft (“AD” for “Air Data” block on FIG. 1), which participate in the reconstitution of the flight phase;
the position of the throttle M, which in particular supplies the information about the thrust requirement,
data W supplied by the airplane sensors, such as “Weight on Wheel” data or gears extended and gears folded,
TM data supplied by the sensors of the turbine engine, particularly to define the transient/stabilized state thereof, and also to supply information about the limitations related to the operability of the compressors.

These different data are used by the unit 2 to determine the flight phase and the level of mechanical power required of the engine for the flight. Said unit 2 deduces therefrom the distribution of the power draw to be applied between the two generators 3 and 4. In the stabilized rating of the turbine engine, each flight phase and each expected level of mechanical power has a corresponding optimized power distribution, determined previously and stored in the memory in the unit 2.

The identification of the flight phases by the unit 2 can be done as follows:
Take-off: throttle M in the take-off position, altitude and speed in the take-off envelope;
Climb: throttle M in the minimum “climb” position or above; altitude and speed outside the take-off phase conditions;
Cruise: rating (or position of the throttle M) between a cruise minimum and a climb threshold, altitude greater than a cruise threshold altitude;
Descent: rating (or position of the throttle M) below a threshold, gears retracted and altitude greater than a cruise threshold altitude;
Approach: rating (or position of the throttle M) below a threshold, gears extended and not folded
Ground idle: rating (or position of the throttle M) less than a threshold trains extended and folded.

Thus, the distribution of the draws is managed dynamically by flight phase, according to the engine-specific requirements, while meeting the overall power requirements of the airplane.

An example of distribution for different flight phases is given in the table below.

| | | Climb | Climb | Climb | Climb | Climb | |
|---|---|---|---|---|---|---|---|
| | | 1500 ft | 10k ft | 21111 ft | 29753 | 35k ft | |
| | | (457 m)/ | (3 048 m)/ | (6 434 m)/ | (9 068 m)/ | (10 668m)/ | |
| | TKOF | M0.388 | M0.488 | M0.602 | M0.714 | M0.77 | Cruise |
| 100% | 100% | 100% | 100% | 40% HP/ | 60% HP/ | 80% HP/ | 40% HP/ |
| NPE | HP | HP | HP | 60% LP | 40% LP | 20% LP | 60% LP |

### Where:

NPE denotes the non-propulsive energy and the level of mechanical power drawn from the engine,
100% NPE denotes the reference level with respect to which the distribution between the power draw from the HP shaft and the power draw from the BP shaft is performed.

This distribution is determined by the unit 2 according to the rules it has stored in its memory. The example given below allows an optimization of the draws with the objective of minimizing the SFC consumption of the engine.

It is particularly suitable in the case of an engine configuration which is ducted with a UHBR or Ultra High Bypass Ratio).
Take-off phase (TKOF):
   the electrical power is 100% drawn from the generator 3 (HP shaft);
Climb phases (Climb)
   up to 21.000 Feet (6 400 m), the electrical power is 100% drawn from the generator 3 (HP shaft) (“Climb 1500 ft (457 m)/M0.388” and “Climb 10 kft (3 048 m)/M0.488” phases in the table above);
   up to 29.700 Feet (9 052 m), the electrical power is 40% drawn from the generator 3 (HP shaft) and 60% drawn from the generator 4 (LP shaft) (“Climb 21.111 ft (6 434 m)/M0.602” phase in the table above);
   from 29.700 Feet (9 052 m) up to 35.000 Feet (10 668 m), the electrical power is 60% drawn from the generator 3 (HP shaft) and 40% drawn from the generator 4 (LP shaft) (“Climb 29753 ft (9 068 m)/M0.714” phase in the table above);
   above 35.000 Feet (10 668 m), the electrical power is 80% drawn from the generator 3 (HP shaft) and 20% drawn from the generator 4 (LP shaft) (“Climb 35 kft (10 668 m)/M0.77” phase in the table above).
Cruise (from 21.000 Feet (6 400 m)):
   the electrical power is 40% drawn from the generator 3 (HP shaft) and 60% drawn from the generator 4 (LP shaft) (“Cruise” phase in the table above).

By way of example, the amounts involved in terms of SFC consumption for such a UHBR engine are as follows:

| | | Climb | Climb | Climb | Climb | Climb | |
|---|---|---|---|---|---|---|---|
| | | 1500 ft | 10k ft | 20k ft | 30k ft | 35k ft | |
| NPE | | (457 m)/ | (3 048 m)/ | (6 096 m)/ | (9 144 m)/ | (10 668 m)/ | |
| (%) | TKOF | M0.39 | M0.49 | M0.60 | M0.71 | M0.77 | Cruise |
| 100 | 0.00% | 0.00% | 0.00% | −0.02% | −0.02% | −0.02% | −0.08% |

More generally, the distribution rules possessed by the control unit 2 are determined for a given engine or type of turbine engine, as a function of a desired optimization, according to the level of mechanical power required of the engine for the flight and depending on the flight phase.

The optimization of the SFC consumption is a possible optimization objective for a twin-spool or three-spool turbine engine.

An optimization table is then as follows:

| Altitude | | Take-off | Climb | Cruise |
|---|---|---|---|---|
| 0 ft | | 100% HP/0% LP | 100% HP/0% LP | |
| 10k ft | (3 048 m) | 100% HP/0% LP | 100% HP/0% LP | |
| 15k ft | (4 572 m) | 100% HP/0% LP | 100% HP/0% LP | |
| 21k ft | (6 400 m) | (100% HP/0% LP) | 40% HP/60% LP | (40% HP/60% LP) |
| 29.7k ft | (9 052 m) | | 60% HP/40% LP | 40% HP/60% LP |
| 35k ft | (10 668 m) | | 80% HP/20% LP | 40% HP/60% LP |

The optimization may also depend on the overall level of power drawn. The HP/LP distribution optimum can then change according to this level of draw. Other optimization objectives are of course possible.

The optimization logics can in particular be very different from one phase to another.

In particular, a careful choice of the distribution of draws to minimize the thrust on the points at idle (ground & descent).

In the case of the optimization of the thrust in descent, the distribution of the draws is established as a function of the architecture of the airplane and in particular of its idle thrust specifications related, inter alia, to the lift-to-drag ratio of the wing.

For example, an optimization table for the descent thrust can be as follows:

| | |
|---|---|
| Altitude | Distribution |

| | | |
|---|---|---|
| 1.5k ft | (457 m) | −20% HP/120% LP |
| 10k ft | (3 048 m) | −40% HP/140% LP |
| 20k ft | (6 096 m) | 0% HP/100% LP |
| 30k ft | (9 144 m) | −20% HP/120% LP |
| 35k ft | (10 668 m) | −20% HP/120% LP |

where a negative distribution corresponds an injection of power, the values being chosen such that the power transfer between the shafts is balanced and the motor does not draw any power from other sources of the aircraft.

The minimization of the “Idle ground” thrust meanwhile makes it possible to limit the wear and temperature of the brakes on the airplane taxiing phases.

Yet another possibility is optimizing the distribution of the draws to limit the turbine outlet temperature (TGT). Specifically, operation in ground idle under hot ambient temperature conditions is conventionally limited by the turbine outlet temperature, which makes it necessary to raise the idle level again to obtain an acceptable turbine outlet temperature for the materials of the afterbody of the turbine engine. A carefully-chosen dynamic distribution of the draws makes it possible to limit the turbine outlet temperature.

An optimized distribution for this objective is as follows: 60% HP/40% LP.

Yet another possible optimization, in particular for the approach phase, is the minimization of the acceleration times.

An optimized distribution for this objective is as follows: 0% HP/100% LP

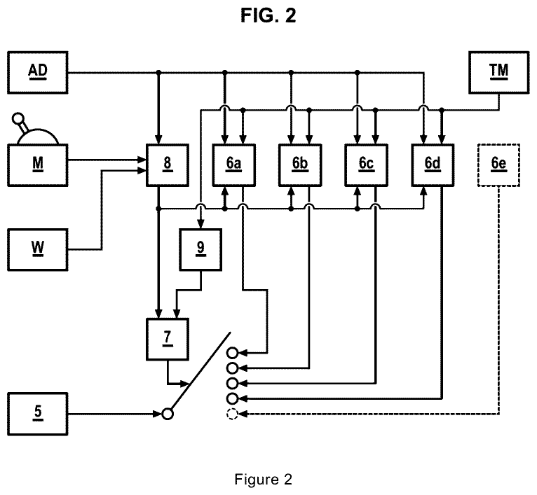

As illustrated in FIG. 2, the control unit 2 has incorporated sub-units 6a to 6e for optimization according to the different possible logics, as well as a selection logic 7, a sub-unit 8 for determining the flight phase and a sub-unit 9 for determining the stabilized state of the turbine engine.

The sub-units 6a to 6e are supplied with flight data (altitude, speed, etc.), and also by the data TM of the sensors of the turbine engine 1 (turbine outlet temperature for example)

The sub-unit 8 for determining the flight phase receives data such as the position of the throttle M, which in particular supplies information about the thrust requirement, or else data W supplied by sensors of the airplane such as “gears extended” and “gears folded”.

The sub-unit 9 meanwhile receives engine data TM supplied by the sensors of the turbine engine, particularly to define the transient/stabilized state thereof, and also to supply information about the limitations related to the operability of the compressors.

The output of said unit 8 for determining the flight phase is sent to the selection logic 7 which queries one of the sub-units 6a to 6e as a function of the identified flight phase so that the selected sub-unit provides, using the stored optimization tables, an optimized distribution of the draws as a function of these data and of the optimization objective that corresponds to it and that corresponds to the flight phase.

An example of an optimization choice as a function of the phase can be as follows (stabilized engine):
Take-off: optimization of the specific fuel consumption (SFC) (sub-unit 6a);
Climb: optimization of the specific fuel consumption (SFC) (sub-unit 6a);
Cruise: optimization of the specific fuel consumption (SFC) (sub-unit 6a);
Descent: optimization of the thrust (sub-unit 6b);
Landing approach: optimization of the acceleration times (sub-unit 6c);
Ground idle: optimization of the turbine outlet temperature TGT (sub-unit 6d).

Other optimization choices are of course possible (sub-unit 6e). In particular, for the idle phase, the optimization can also be done for the residual thrust or on a trade-off between an optimization for the residual thrust and an optimization for the turbine outlet temperature TGT.

1-10. (canceled)

11. A system for managing the drawing of mechanical power from a twin-spool or three-spool aircraft turbine engine comprising at least a first turbine and a second turbine,
wherein at least a first electric machine and a second electric machine are suitable for recovering mechanical energy:
for said first electric machine, from a shaft driven by the first turbine of the turbine engine,
for said second electric machine, from a shaft driven by the second turbine of the turbine engine, and
wherein said system includes:
a managing unit which controls the draws of electrical power and the electrical distribution across the different equipment items and consumption systems of the aircraft, and
control unit suitable for transmitting a distribution of the draws which it determines according to the flight phase of the aircraft, to said managing unit,
said control unit being suitable for storing draw distribution rules for different optimization logics, said stored draw distribution rules corresponding to optimization logics chosen from among the following group: optimization of the specific fuel consumption and/or optimization of the thrust and/or optimization of the acceleration times and/or optimization of the turbine outlet temperature.

12. A method for managing the drawing of mechanical power from a twin-spool or three-spool aircraft turbine engine comprising at least a first turbine and a second turbine,
wherein at least a first electric machine and a second electric machine are suitable for recovering mechanical energy:
for the first electric machine, from a shaft driven by the first turbine of the turbine engine, and
for the second electric machine, from a shaft driven by the second turbine of the turbine engine,
the method implementing a control of the draws of electrical power and of the electrical distribution across the different equipment items and consumption systems of the aircraft,
wherein the distribution of these draws between the first electric machine and the second electric machine is controlled dynamically as a function of the flight phase, wherein a control unit stores draw distribution rules for different optimization logics, said stored draw distribution rules corresponding to optimization logics chosen from among the following group: optimization of the specific fuel consumption and/or optimization of the thrust and/or optimization of the acceleration times and/or optimization of the turbine outlet temperature.

13. The method as claimed in claim 12, wherein the control unit implements, as a function of items of information transmitted by the aircraft, the determining of the flight phase in which the aircraft is found, and transmits, to a managing system which controls the draws of electrical power, a distribution to be applied, said distribution being a function of an optimization logic specific to the flight phase thus determined.

14. The method as claimed in claim 13, wherein the determining of the flight phase and of the distribution by the control unit is a function of input data comprising:
the flight data of the aircraft;
the thrust requirement and/or the position of the throttle;
data supplied by the airplane sensors such as gears extended and gears folded, and
data supplied by the sensors of the turbine engine, particularly to define the transient/stabilized state thereof.

15. The method as claimed in claim 14, wherein the optimization logics of the different flight phases comprise:
take-off: optimization of the specific fuel consumption;
climb: optimization of the specific fuel consumption; and
cruise: optimization of the specific fuel consumption;

16. The method as claimed in claim 15, wherein the optimization logics of the different flight phases further comprise:
descent: optimization of the thrust;
landing approach: optimization of the acceleration times; and
ground idle: optimization of the turbine outlet temperature.

17. The method as claimed in claim 15, wherein said stored draw distribution rules take into account the altitude of said aircraft.

18. An assembly including a twin-spool or three-spool aircraft turbine engine comprising at least a first turbine and a second turbine,
wherein at least a first electric machine and a second electric machine are suitable for recovering a mechanical energy,
the first electric machine from a shaft driven by the first turbine of the turbine engine, and
the second electric machine from a shaft driven by the second turbine of the turbine engine, and
wherein said assembly further includes a managing system as claimed in claim 11.

19. The assembly as claimed in claim 18, wherein the turbine engine is of twin-spool type, the electric machines being two generators suitable for recovering the mechanical energy, one from the high-pressure shaft of the turbine engine, the other from the low-pressure shaft.

20. An aircraft including the system as claimed in claim 11.

21. An aircraft including the assembly as claimed in claim 18.
